(19) United States
(12) Patent Application Publication
(10) Pub. No.: US 2009/0222268 A1
(43) Pub. Date: Sep. 3, 2009

(54) SPEECH SYNTHESIS SYSTEM HAVING ARTIFICIAL EXCITATION SIGNAL

(75) Inventors: Xueman Li, Burnaby (CA); Phillip A. Hetherington, Port Moody (CA); Shahla Parveen, Vancouver (CA); Tommy TSZ Chun Chiu, Port Coquitlam (CA)

Correspondence Address: HARMAN - BRINKS HOFER CHICAGO;Brinks Hofer Gilson & Lione, P.O. Box 10395, Chicago, IL, 60610, US

(73) Assignee: QNX SOFTWARE SYSTEMS (WAVEMAKERS), INC., VANCOUVER (CA)

(21) Appl. No.: 12/041,302

(22) Filed: Mar. 3, 2008

(51) Int. Cl. G10L 13/02

(52) U.S. Cl. 704/261; 704/E13.002

(57) ABSTRACT

A speech synthesis system synthesizes a speech signal corresponding to an input speech signal based on a spectral envelope of the input speech signal. A glottal pulse generator generates a time series of glottal pulses, that are processed into a glottal pulse magnitude spectrum. A shaping circuit shapes the glottal pulse magnitude spectrum based on the spectral envelope and generates a shaped glottal pulse magnitude spectrum. A harmonic null adjustment circuit reduces harmonic nulls in the shaped glottal pulse magnitude spectrum and generates a null-adjusted synthesized speech spectrum. An inverse transform circuit generates a null-adjusted time-series speech signal. An overlap and add circuit synthesizes the speech signal based on the null-adjusted time-series speech signal.

### BACKGROUND OF THE INVENTION

1. Technical Field

This disclosure relates to speech synthesis. In particular, this disclosure relates to synthesizing speech using an artificially generated excitation signal.

2. Related Art

Users may access communication systems to transmit speech. The systems may include wireless telephones, land-line telephones, hands-free systems, remote communication devices and other communication systems. Reducing the bandwidth needed to transmit voice signals may increase system efficiency and reduce costs. Some systems compress speech signals to reduce its bandwidth, which reduces signal quality. Some systems may synthesize voice signals to reduce the signal's bandwidth. These band-limited signals may not provide natural sounding speech.

### SUMMARY

A speech synthesis system synthesizes a speech signal corresponding to an input speech signal based on a spectral envelope. A glottal pulse generator generates a time series of glottal pulses, and a transform circuit generates a glottal pulse magnitude spectrum based on the time series of glottal pulses. A shaping circuit shapes the glottal pulse magnitude spectrum based on the spectral envelope and generates a shaped glottal pulse magnitude spectrum. A harmonic null adjustment circuit reduces harmonic nulls in the shaped glottal pulse magnitude spectrum and generates a null-adjusted synthesized speech spectrum. An inverse transform circuit transforms the null-adjusted synthesized speech spectrum to the time domain and generates a null-adjusted time-series speech signal. An overlap and add circuit synthesizes the speech signal based on the null-adjusted time-series speech signal.

Other systems, methods, features, and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like-referenced numerals designate corresponding parts throughout the different views.

FIG. 1 is a speech communication system.

FIG. 2 is a speech synthesis system.

FIG. 3 is a time domain speech signal.

FIG. 4 is a glottal pulse time sequence.

FIG. 5 is a glottal pulse generation process.

FIG. 6 is a spectral envelope and glottal pulse magnitude spectrum.

FIG. 7 is a shaped glottal pulse magnitude spectrum.

FIG. 8 is a null-adjusted synthesized speech spectrum.

### DETAILED DESCRIPTION OF THE PREFERRED EMBODIMENTS

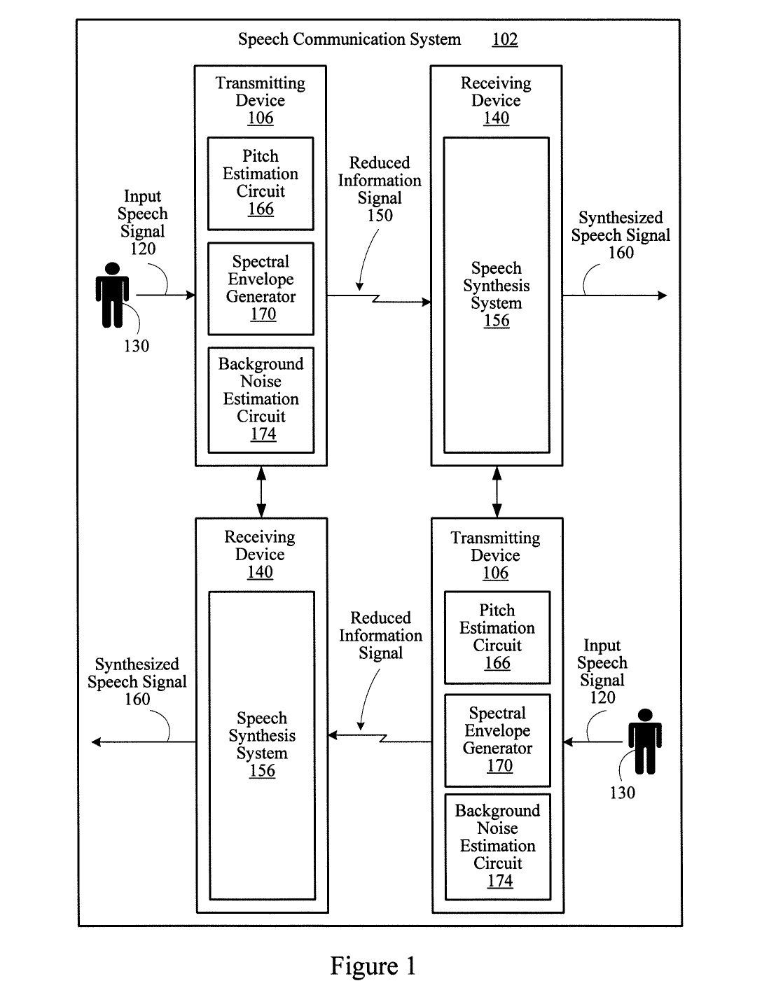

FIG. 1 is a speech communication system 102, such as a telephone network or other communication system. A transmitting device 106 may receive an input speech signal 120 from a user 130, and may transmit speech information or speech parameters to a corresponding receiving device 140. The transmitting and receiving devices 106 and 140 may be wireless telephones, land-line telephones, hands-free systems, remote communication devices, codec devices, or other communication devices. To reduce the bandwidth of a transmitted signal, the transmitting device 106 may not transmit the actual speech signal. Rather, the transmitting device 106 may transmit reduced information signals 150 to the receiving device 140. Reducing the amount of data transmitted may increase system capacity and efficiency, and may reduce network costs.

The receiving device 140 may include a speech synthesis system 156. The speech synthesis system 156 may be a unitary part of the receiving device 140 or may be separate from the receiving device 140. The speech synthesis system 156 may receive the reduced information signals 150 and may synthesize or reconstruct the original speech signal (input speech signal 120) to provide a reconstructed or synthesized speech signal 160.

FIG. 1 shows a transmission of the reduced information signals 150 and subsequent signal reconstruction as full-duplex communication. Each communication device, such as a telephone, may include the transmitting device 106 or portion and the receiving device 140 or portion, where each receiving device or portion 140 may include the speech synthesis system 156. Some transmitting device 106 may include a pitch estimation circuit 166, a spectral envelope generator 170, and a background noise estimation circuit 174. The pitch estimation circuit 166, the spectral envelope generator 170, and the background noise estimation circuit 174 may be a unitary part of the transmitting device 106 or may be remote from the transmitting device.

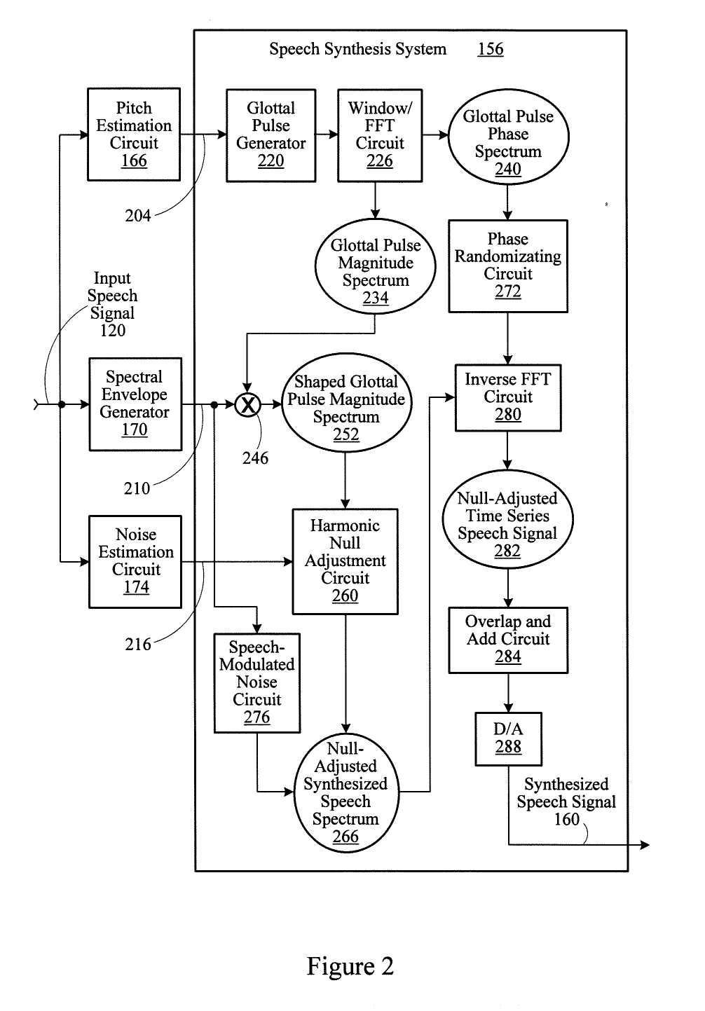

FIG. 2 is the speech synthesis system 156. The pitch estimation circuit 166 may estimate a pitch of the input speech signal 120 on a block-by-block or frame-by-frame basis. The pitch estimation circuit 166 may estimate pitch 204. The spectral envelope generator 170 may generate a spectral envelope 210 of the input speech signal 120 on a block-by-block or frame-by-frame basis, which may model a human vocal tract. The background noise estimation circuit 174 may generate a background noise signal 216 corresponding to the input speech signal 120 on a frame-by-frame basis or block-by-block, which may add a natural or “life-like” quality to the reconstructed or synthesized speech signal 160. The speech synthesis system 156 may generate or reconstruct natural sounding speech based on the spectral envelope 210 of the speech signal by using the estimated pitch signal 204 to generate continuous phase.

The transmitting device 106 may transmit the estimated pitch signal 204, the spectral envelope 210, and the background noise signal 216 to the receiving device 140 using less bandwidth than the bandwidth needed to transmit a digitized speech signal. In some applications, the estimated pitch signal 204, the spectral envelope 210, and the background noise signal 216 may not include phase information.

The speech synthesis system 156 may process the speech signal on a frame-by-frame basis. The estimated pitch signal 204, the spectral envelope 210, and the background noise signal 216 may be transmitted to the speech synthesis system 156 in a frame-by-frame format (block-by-block). Each frame or buffer, may comprise about 256 samples. Each frame may overlap a previous frame by about 50%. The amount of overlap may vary between about 20% and about 80%. A frame may be about 10 milliseconds in length. A frame length may vary from about 4 milliseconds to about 50 milliseconds.

A glottal pulse generator 220 may receive the estimated pitch signal 204 from the pitch estimation circuit 166. The estimated pitch signal 204 may represent an estimated pitch for a particular frame, and may be a single pitch value, that is, one pitch value per frame. The pitch may be substantially constant within a signal frame, and may vary slightly from frame-to-frame. The pitch may be estimated using circuits and processes, for example that track the periodic components in a speech signal using an adaptive filter and calculate the autocorrelation of the speech signal. Other such processes and circuits may measure the duration between harmonic peaks in the power spectrum of the speech signal. Other circuits and/or processes may be used to estimate the pitch and provide the pitch information to the glottal pulse generator 220. Based on the pitch information, the glottal pulse generator 220 may generate or synthesize “glottal pulses.” The glottal pulses or “excitation signal” may emulate pitch sweeps of the human voice.

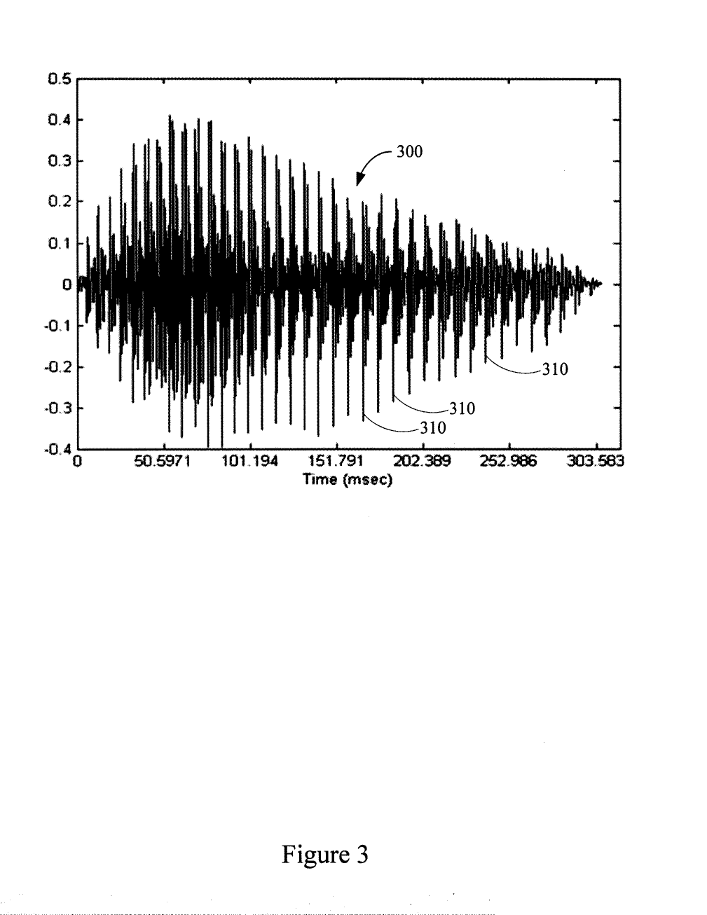

FIG. 3 is a waveform 300 representing human speech in the time domain. The waveform 300 may correspond to the utterance of the word “five.” A time sequence of glottal pulses 310 are shown as “spikes” or impulse functions. The duration of the speech signal may be about 300 milliseconds in the example of FIG. 3.

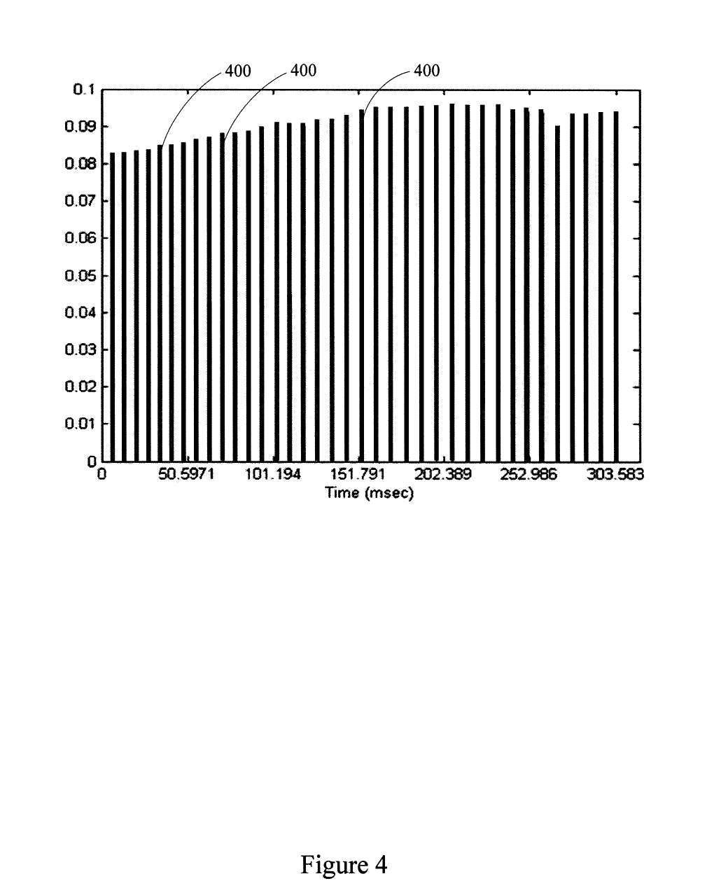

FIG. 4 shows time domain glottal pulses 400 generated by the glottal pulse generator 220 based on the pitch information. The glottal pulses 400 of FIG. 4 may directly correspond to the time domain speech signal of FIG. 3. Several glottal pulses 400 may be generated within a single frame, which may depend on the pitch information provided to the glottal pulse generator 220. In some processes, no glottal pulses may be generated for a particular frame. In other processes, one or more glottal pulses may be generated for a particular frame. The glottal pulses 400 may be represented by impulse functions.

The interval between glottal pulses 400 may be a constant or substantially constant value because it may be based on the pitch information, which also may be constant or substantially constant. The pitch may vary slowly from frame-to-frame. The interval between glottal pulses in subsequent frames may vary relative to the varying pitch. The glottal pulses 400 may be synthesized and may not contain information that is imparted by the human vocal tract in an actual speech signal. The glottal pulses may be “shaped” to vary the magnitude.

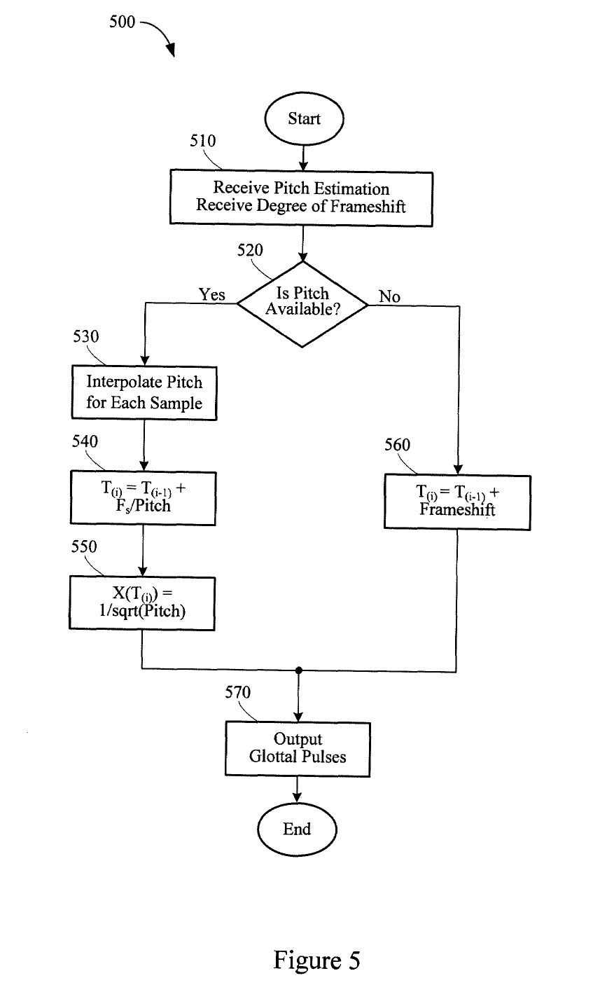

FIG. 5 is a process 500 for generating the glottal pulses based on the pitch information. The process may generate the glottal pulses 400 of FIG. 4. The glottal pulses 400 may be in the time domain. For example, a speech signal may be sampled at about an 8 KHz rate with an estimated pitch of about 100 Hz. About 100 glottal pulses may be generated in a one-second sample (about 8000 sample points). This may represent about 64 frames (256 sample points per frame, 50% overlap). Thus, each frame, on average, may contain about 3 glottal pulses, where each glottal pulse, on average, may “span” or be based on about 80 sample points. Each frame may contain no glottal pulses, or one or more glottal pulses.

The pitch estimation and the degree of frame overlap may be provided to the glottal pulse generator 220 (Act 510). The degree of frame overlap may be a predetermined value. Pitch information may or may not be available for a particular frame. Pitch information may be available for a “voiced” signal, such as a vowel. Pitch information may not be available for an “unvoiced” signal, such a consonant or anatomically generated sounds. Pitch information may not be available for a voiced signal if the pitch estimation fails.

If the current and last frame pitch estimates are available (Act 520), a pitch for each sample point within the frame may be estimated using a linear or nonlinear interpolation between the pitch values (Act 530). This may smooth the pitch transitions from frame-to-frame. The position in the time sequence of next glottal pulse “T₍ᵢ₎” may be updated (Act 540) by the pitch value associated with the sample point “T₍ᵢ₋₁₎” according to Equation 1 below, where “Fₛ” is the sample rate.

The glottal pulse amplitude “X(T₍ᵢ₎)” may be set about equal to the inverse of the square root of the pitch (Act 550), as shown by Equation 2. If the pitch information is not available, the sample point may be updated by the amount of frame shift (Act 560), as shown by Equation 3 below. The glottal pulses 400 may be output as time domain pulses (Act 570).

T₍ᵢ₎=T₍ᵢ₋₁₎+Fₛ/pitch (Eqn. 1)

X(T₍ᵢ₎)=1/sqrt(pitch) (Eqn. 2)

T₍ᵢ₎=T₍ᵢ₋₁₎+frame shift (Eqn. 3)

A fast Fourier transform (FFT) and windowing circuit 226 (FFT circuit) may receive the time sequence of glottal pulses. The FFT circuit may transform signals from the time domain to the frequency domain. The FFT circuit 226 may apply a short-time FFT and may generate a glottal pulse magnitude spectrum 234 and a glottal pulse phase spectrum 240 on a frame-by-frame basis.

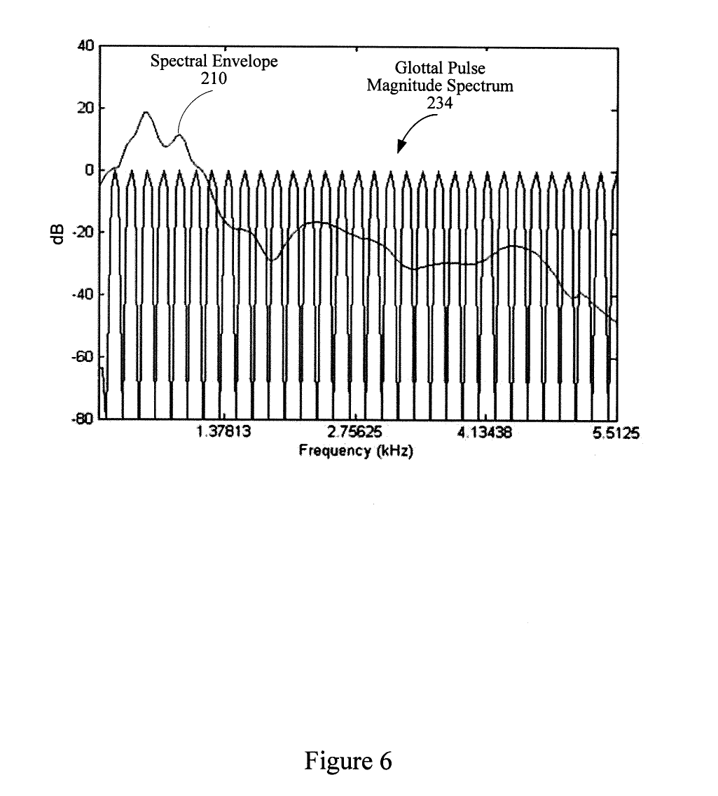

FIG. 6 is the glottal pulse magnitude spectrum 234 shown as a series of synthesized harmonics with the spectral envelope 210 of the input speech signal 120 superimposed over the glottal pulse magnitude spectrum 234. The “distance” in frequency between each harmonic may represent the pitch of the frame. The FFT circuit 226 may generate the glottal pulse magnitude spectrum 234 by applying a hanning window of about 23.2 milliseconds and performing an FFT at a frame rate of about 11.6 milliseconds. Because the glottal pulses of FIG. 4 may be generated in the time domain and may be smoothly interpolated from frame to frame, the glottal pulse magnitude spectrum 234 of FIG. 6 may contain the harmonic information, while the phase of the spectrum (glottal pulse phase spectrum 240) may ensure smoothness of harmonic track from frame to frame.

A multiplier or shaping circuit 246 of FIG. 2 may multiply the glottal pulse magnitude spectrum 234 by the spectral envelope 210 to generate a shaped glottal pulse magnitude spectrum 252 of FIG. 2. The glottal pulse magnitude spectrum 234 may be adjusted or “shaped” according to the spectral envelope 210 so that the glottal pulse harmonics “fit” within the spectral envelope 210.

The spectral envelope generator 170 may provide the spectral envelope signal 210 to the multiplier circuit 246. If the glottal pulse magnitude spectrum 234 and the spectral envelope 210 are transformed to the decibel (dB) domain, they may be added rather than multiplied. The spectral envelope 210 may be generated using various circuits and processes, such as peak picking and interpolation to speech magnitude spectrum, and linear predictive modeling. Other circuits and/or processes may be used to generate the spectral envelope 210.

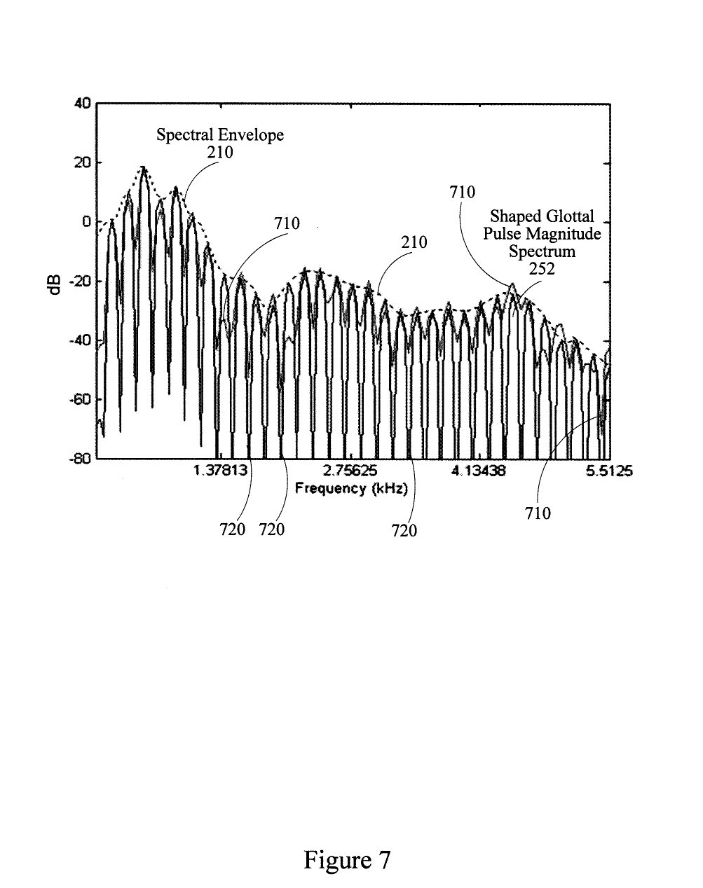

FIG. 7 is the shaped glottal pulse magnitude spectrum 252, which may be the product of the glottal pulse magnitude spectrum 234 and the spectral envelope 210. The magnitude of each harmonic component in the glottal pulse magnitude spectrum 234 may be multiplied by the inverse of the square root of the estimated pitch, as shown in Equation 2. A frequency domain voice signal 710 corresponding to the input speech signal 120 is shown in FIG. 7 to indicate the variation between the actual frequency domain voice signal and the shaped glottal pulse magnitude spectrum 252. The shaped glottal pulse magnitude spectrum 252 may represent a synthesized speech signal in the frequency domain.

The shaped glottal pulse magnitude spectrum 252 may have deep harmonic nulls 720 when the estimated pitch is stable over several frames. The deep harmonic nulls 720 may have an amplitude as low as about −80 dB. Synthesized speech signals having deep harmonic nulls may sound “mechanical” or artificial to the human listener. Deep harmonic nulls 720 may be caused, in part, by glottal pulse harmonics that are evenly spaced with little or no variation. Because the shaped glottal pulse magnitude spectrum 252 may be “synthesized,” there may be little or no noise. Thus, there may be little or no signal between harmonics, which may cause the deep harmonic nulls 720.

Adding background noise or a “comfort noise” signal to the shaped glottal pulse magnitude spectrum 252 may reduce the depth of the harmonic nulls 720. This may increase the “life-like” or natural quality of the synthesized or reconstructed speech signal 160. A harmonic null adjustment circuit 260 of FIG. 2 may receive the shaped glottal pulse magnitude spectrum 252 and may process the spectrum based on the background noise signal 216 received from the noise estimation circuit 174. The harmonic null adjustment circuit 260 may adjust the depth of the harmonic nulls 720 and may generate a null-adjusted synthesized speech spectrum 266 of FIG. 2.

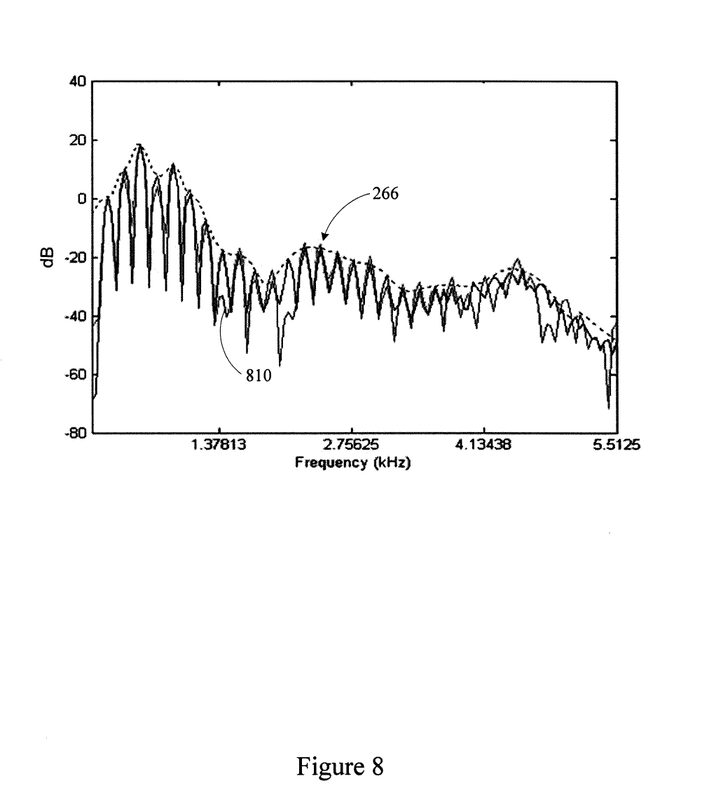

FIG. 8 is the null-adjusted synthesized speech spectrum 266. The background noise or comfort noise may have a fixed spectral shape. The power of the background noise or comfort noise may vary according to the power of the input speech signal 120 to provide a signal having a predetermined signal-to-noise ratio. A frequency domain voice signal 810 corresponding to the input speech signal 120 shown in FIG. 8 shows the differences between the actual frequency domain voice signal and the null-adjusted synthesized speech spectrum 266. The null-adjusted synthesized speech spectrum 266 may approximate the frequency domain representation of the input speech signal 120 shown in FIG. 8.

The background noise or comfort noise may be generated using various circuits and/or processes, such as measuring actual noise at predetermined times or during speech pauses, monitoring a noise spectrum at multiple frequency bands (with and without weighting), adaptively filtering and tracking noise components, injecting noise having randomized phase components, and injecting noise based on spectral content and gain values. Other processes and or circuits may be used to generate or inject the background noise or comfort noise. Adding the background noise or comfort noise may cause the null-adjusted synthesized speech spectrum 266 to approximate the frequency domain representation of the input speech signal 120 shown in FIG. 8.

A phase randomizing circuit 272 of FIG. 2 may randomize the phase of the glottal pulse phase spectrum 240. Randomizing the phase of the glottal pulse phase spectrum 240 may reduce the depth of the harmonic nulls in the null-adjusted synthesized speech spectrum 266. This may increase the “life-like” or natural quality of the synthesized or reconstructed speech signal 160. Randomizing the phase of the glottal pulse phase spectrum 240 may cause the null-adjusted synthesized speech spectrum 266 to approximate the frequency domain representation of the input speech signal 120 shown in FIG. 8.

The phase may be randomized for frequencies greater than a predetermined cutoff frequency, such as about 3.7 KHz. The cutoff frequency may vary based on a signal-to-noise ratio. The phase may be randomized for “high” frequencies because human speech may have stronger harmonics in the lower frequencies rather than in the upper frequencies. Randomizing the phase may not change the total power, but may change the spectral shape. The phase may be randomized based on generating a random number for real and imaginary portions of the phase information. The real and imaginary numbers may be based on a uniform random distribution.

The depth of the harmonic nulls 720 may be adjusted by adding speech-modulated random noise to the null-adjusted synthesized speech spectrum 266. A speech-modulated random noise circuit 276 of FIG. 2 may generate speech modulated noise based on the spectral envelope 210 using a frequency-dependant scaling factor. The frequency-dependant scaling factor may range from about 0 to about 1. The speech-modulated noise may be added for frequencies greater than a predetermined cutoff frequency, such as about 3.7 KHz.

An inverse FFT circuit 280 of FIG. 2 may receive the null-adjusted synthesized speech spectrum 266 and the output of the phase randomizing circuit 272, and may perform an inverse FFT to generate a null-adjusted time-series speech signal 282, which may be a complete spectrum. The inverse FFT circuit 280 may transform the null-adjusted synthesized speech spectrum 266 into the time domain. An overlap and add circuit 284 of FIG. 2 may apply the proper framing to the null-adjusted time-series speech signal to account for the overlapping frame format of the inputs provided to the speech synthesis system 156. A digital-to-analog converter 288 of FIG. 2 may convert the digital output of the overlap and add circuit 284 to generate the reconstructed or synthesized speech signal 160.

The logic, circuitry, and processing described above may be encoded in a computer-readable medium such as a CDROM, disk, flash memory, RAM or ROM, an electromagnetic signal, or other machine-readable medium as instructions for execution by a processor. Alternatively or additionally, the logic may be implemented as analog or digital logic using hardware, such as one or more integrated circuits (including amplifiers, adders, delays, and filters), or one or more processors executing amplification, adding, delaying, and filtering instructions; or in software in an application programming interface (API) or in a Dynamic Link Library (DLL), functions available in a shared memory or defined as local or remote procedure calls; or as a combination of hardware and software.

The logic may be represented in (e.g., stored on or in) a computer-readable medium, machine-readable medium, propagated-signal medium, and/or signal-bearing medium. The media may comprise any device that contains, stores, communicates, propagates, or transports executable instructions for use by or in connection with an instruction executable system, apparatus, or device. The machine-readable medium may selectively be, but is not limited to, an electronic, magnetic, optical, electromagnetic, or infrared signal or a semiconductor system, apparatus, device, or propagation medium. A non-exhaustive list of examples of a machine-readable medium includes: a magnetic or optical disk, a volatile memory such as a Random Access Memory “RAM,” a Read-Only Memory “ROM,” an Erasable Programmable Read-Only Memory (i.e., EPROM) or Flash memory, or an optical fiber. A machine-readable medium may also include a tangible medium upon which executable instructions are printed, as the logic may be electronically stored as an image or in another format (e.g., through an optical scan), then compiled, and/or interpreted or otherwise processed. The processed medium may then be stored in a computer and/or machine memory.

The systems may include additional or different logic and may be implemented in many different ways. A controller may be implemented as a microprocessor, microcontroller, application specific integrated circuit (ASIC), discrete logic, or a combination of other types of circuits or logic. Similarly, memories may be DRAM, SRAM, Flash, or other types of memory. Parameters (e.g., conditions and thresholds) and other data structures may be separately stored and managed, may be incorporated into a single memory or database, or may be logically and physically organized in many different ways. Programs and instruction sets may be parts of a single program, separate programs, or distributed across several remote or local memories and processors. The systems may be included in a variety of electronic devices, including a cellular phone, a headset, a hands-free set, a speakerphone, communication interface, or an infotainment system.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A speech synthesis system adapted to synthesize a speech signal corresponding to an input speech signal, based on a spectral envelope of the input speech signal, the system comprising:
a glottal pulse generator configured to generate a time series of glottal pulses;
a transform circuit configured to generate a glottal pulse magnitude spectrum based on the time series of glottal pulses;
a shaping circuit configured to shape the glottal pulse magnitude spectrum in accordance with the spectral envelope to generate a shaped glottal pulse magnitude spectrum;
a harmonic null adjustment circuit configured to reduce harmonic nulls in the shaped glottal pulse magnitude spectrum to generate a null-adjusted synthesized speech spectrum;
an inverse transform circuit configured to transform the null-adjusted synthesized speech spectrum to the time domain and generate a null-adjusted time-series speech signal; and
an overlap and add circuit configured to synthesize the speech signal based on the null-adjusted time-series speech signal.

2. The system of claim 1, where the time series of glottal pulses are generated based on pitch information of the input speech signal.

3. The system of claim 2, where the harmonic null adjustment circuit reduces the harmonic nulls based on a background noise signal corresponding to the input speech signal.

4. The system of claim 3, where the spectral envelope, the pitch information, and the background noise signal are processed on a frame-by-frame basis.

5. The system of claim 4, where the overlap and add circuit compensates for frame shift of the pitch value, the spectral envelope and the background noise signal.

6. The system of claim 1, where the transform circuit generates a glottal pulse phase spectrum.

7. The system of claim 6, further comprising a phase randomizing circuit configured to randomize a phase of the glottal pulse phase spectrum.

8. The system of claim 7, where randomizing the phase of the glottal pulse phase spectrum reduces harmonic nulls in the null-adjusted synthesized speech spectrum.

9. A speech synthesis system for synthesizing a speech signal corresponding to an input speech signal, based on a pitch value, a spectral envelope and a noise signal of the input speech signal, the system comprising:
a glottal pulse generator configured to generate a time series of glottal pulses based on the pitch value;
a time domain to frequency domain transform circuit configured to generate a glottal pulse magnitude spectrum based on the time series of glottal pulses;
a shaping circuit configured to shape the glottal pulse magnitude spectrum in accordance with the spectral envelope and generate a shaped glottal pulse magnitude spectrum;
a harmonic null adjustment circuit configured to reduce harmonic nulls in the shaped glottal pulse magnitude spectrum based on background noise signal, to generate a null-adjusted synthesized speech spectrum;
a frequency domain to time domain transform circuit configured to transform the null-adjusted synthesized speech spectrum to the time domain and generate a null-adjusted time-series speech signal; and
an overlap and add circuit configured to synthesize the speech signal based on the null-adjusted time-series speech signal.

10. The system of claim 9, where the pitch value, a spectral envelope and a background noise signal correspond to the input speech signal.

11. The system of claim 9, where the synthesized speech signal approximates the input speech signal.

12. The system of claim 10, where the pitch value, the spectral envelope and the background noise signal are provided on a frame-by-frame basis.

13. The system of claim 12, where the overlap and add circuit compensates for frame shift of pitch value, the spectral envelope and the background noise signal.

14. The system of claim 9, where the transform circuit generates a glottal pulse phase spectrum.

15. The system of claim 14, further comprising a phase randomizing circuit configured to randomize a phase of the glottal pulse phase spectrum.

16. The system of claim 15, where randomizing the phase of the glottal pulse phase spectrum reduces harmonic nulls in the null-adjusted synthesized speech spectrum.

17. A method for synthesizing a speech signal corresponding to an input speech signal based on a spectral envelope of the input speech signal, the method comprising:
generating a time series of glottal pulses;
transforming the time series of glottal pulses into a glottal pulse magnitude spectrum;
shaping the glottal pulse magnitude spectrum in accordance with the spectral envelope to generate a shaped glottal pulse magnitude spectrum;
reducing harmonic nulls in the shaped glottal pulse magnitude spectrum to generate a null-adjusted synthesized speech spectrum;
transforming the null-adjusted synthesized speech spectrum to the time domain to generate a null-adjusted time-series speech signal; and
processing the null-adjusted time-series speech signal on a frame-by-frame basis to synthesize the speech signal.

18. The method of claim 17, where the time series of glottal pulses are generated based on pitch information corresponding to the input speech signal.

19. The method of claim 18, where a harmonic null adjustment circuit reduces the harmonic nulls based on a background noise signal corresponding to the input speech signal.

20. The method of claim 19, further comprising processing the spectral envelope, the pitch information, and the background noise signal on a frame-by-frame basis.

21. The method of claim 20, where the overlap and add circuit compensates for frame shift of the pitch value, the spectral envelope and the background noise signal.

22. The method of claim 17, further comprising generating a glottal pulse phase spectrum by transforming the time series of glottal pulses into the frequency domain.

23. The method of claim 22, further comprising randomizing a phase of the glottal pulse phase spectrum.

24. The method of claim 23, where randomizing the phase of the glottal pulse phase spectrum reduces harmonic nulls in the null-adjusted synthesized speech spectrum.

25. A speech synthesis system adapted to synthesize a speech signal corresponding to an input speech signal, based on a spectral envelope of the input speech signal, the system comprising:
a glottal pulse generator configured to generate a time series of glottal pulses;
means for transforming the time series of glottal pulses into the frequency domain to generate a glottal pulse magnitude spectrum;
means for shaping the glottal pulse magnitude spectrum in accordance with the spectral envelope to generate a shaped glottal pulse magnitude spectrum;
means for reducing harmonic nulls in the shaped glottal pulse magnitude spectrum to generate a null-adjusted synthesized speech spectrum;
means for transforming the null-adjusted synthesized speech spectrum into the time domain to generate a null-adjusted time-series speech signal; and
an overlap and add circuit configured to synthesize the speech signal based on the null-adjusted time-series speech signal.

26. The system of claim 25, where the time series of glottal pulses are generated based on pitch information of the input speech signal.

27. The system of claim 26, where the means for reducing harmonic nulls reduces the harmonic nulls based on a background noise signal corresponding to the input speech signal.

28. The system of claim 27, where the spectral envelope, the pitch information, and the background noise signal are processed on a frame-by-frame basis.

29. The system of claim 28, where the overlap and add circuit compensates for frame shift of the pitch value, the spectral envelope and the background noise signal.

30. The system of claim 25, where the means for transforming the time series of glottal pulses into the frequency domain generates a glottal pulse phase spectrum.

31. The system of claim 30, further comprising means for randomizing phase configured to randomize a phase of the glottal pulse phase spectrum.

32. The system of claim 31, where randomizing the phase of the glottal pulse phase spectrum reduces harmonic nulls in the null-adjusted synthesized speech spectrum.
